(19) United States
(12) Patent Application Publication
(10) Pub. No.: US 2017/0285668 A1
(43) Pub. Date: Oct. 5, 2017

(54) PRESSURE RELIEF VALVE APPARATUS AND AN ELECTRONIC SYSTEM FOR CONTROLLING THE SAME

(71) Applicant: KLX INC., Wellington, FL (US)

(72) Inventors: Lorne Randall Moseley, Benton, LA (US); Brandon Carlton Wilkins, Dallas, TX (US)

(21) Appl. No.: 15/474,567

(22) Filed: Mar. 30, 2017

Related U.S. Application Data
(60) Provisional application No. 62/315,495, filed on Mar. 30, 2016.

(51) Int. Cl. G05D 16/20; E21B 43/26; F16K 31/122; F16K 17/00; F16K 37/00

(52) U.S. Cl. CPC G05D 16/2013; F16K 17/00; F16K 37/0083; F16K 37/0091; F16K 31/122; E21B 43/26

(57) ABSTRACT

Provided are methods and systems for controlling a pressure relief valve. An electronic control unit monitors pressure being supplied from a source. If the control unit determines that the monitored pressure is above a threshold pressure, the control unit controls an actuator to move the pressure relief valve to an open position, thereby releasing the pressure from within the system. If the control unit determines that the monitored pressure is at or below the threshold value, the control unit controls the actuator to move the pressure relief valve to a closed position.

### CROSS-REFERENCES TO RELATED APPLICATIONS

This application claims the benefit of U.S. Provisional Patent Application No. 62/315,495, entitled “Pressure Relief Valve Apparatus And An Electronic System For Controlling The Same,” filed on Mar. 30, 2016, which is hereby expressly incorporated herein by reference in its entirety.

### BACKGROUND

### 1. Field

The present disclosure relates generally to fracturing relief valves and, more particularly, to a system and apparatus for relieving pressure in a hydraulic fracturing fluid delivery system.

### 2. Description of the Related Art

Hydraulic fracturing, or fracking, is a process used to recover natural gas, oil, or other fossil fuels from rock layers deep below ground level. A typical hydraulic fracturing process includes multiple trucks pumping a pressurized liquid mixture of water, sand, and chemicals (sometimes referred to as “fracking fluid” or simply “frac fluid”) into a wellhead above the surface, which feeds into a wellbore extending below the surface to the desired depth. The wellbore includes casings that have perforated sections that allow the liquid to escape into the rock layer.

As the pressurized liquid (or “frac fluid”) is pumped through the wellbore below the surface, the pressurized liquid is forced through the perforated sections and into the surrounding formation to cause the rock to fracture. The liquid will continue to flow into these fractures, creating fissures. During the hydraulic fracturing process, the pressure of the liquid is monitored and the process maintains the highest pressure possible to ensure maximum fracturing in the rock.

Because of the nature of the hydraulic fracturing process, fluid pumps and delivery lines that feed the tracking fluid into the wellbore operate under high pressure. The pressure within the system is monitored to ensure that the system operates as desired. However, pressure spikes can occur throughout the system that if sufficiently high could cause piping to break or weaken, ultimately leading to subsequent breaking due to fatigue.

### SUMMARY

The following introduces a selection of concepts in a simplified form in order to provide a foundational understanding of some aspects of the present disclosure. The following is not an extensive overview of the disclosure, and is not intended to identify key or critical elements of the disclosure or to delineate the scope of the disclosure. The following merely presents some of the concepts of the disclosure as a prelude to the more detailed description provided thereafter.

One embodiment of the present disclosure relates to a system for controlling a pressure relief valve, the system comprising: an actuator that operates to move the pressure relief valve between an open position and a closed position; and a control unit that controls operation of the actuator, where the control unit is configured to: monitor hydraulic pressure being supplied from a source, and in response to determining that the pressure is above a threshold pressure, control the actuator to move the pressure relief valve to the open position.

Another embodiment of the present disclosure relates to a method for controlling a pressure relief valve, the method comprising: monitoring, using one or more sensors, hydraulic pressure supplied from a source; in response to determining that the monitored pressure is greater than a threshold value, controlling an actuator to move the pressure relief valve to an open position; and in response to determining that the monitored pressure is less than or equal to the threshold value, controlling the actuator to move the pressure relief valve to a closed position.

Further scope of applicability of the apparatuses and methods of the present disclosure will become apparent from the more detailed description given below. However, it should be understood that the following detailed description and specific examples, while indicating embodiments of the apparatus and methods, are given by way of illustration only, since various changes and modifications within the spirit and scope of the concepts disclosed herein will become apparent to those skilled in the art from the following detailed description.

### BRIEF DESCRIPTION OF THE DRAWINGS

These and/or other aspects will become apparent and more readily appreciated from the following description of the embodiments, taken in conjunction with the accompanying drawings of which:

FIG. 1 is a block diagram illustrating an example system for controlling a pressure relief valve, according to an embodiment.

FIG. 2 is a cutaway view of a hydraulically-actuated relief valve assembly, according to an embodiment.

FIG. 3 is a perspective view of a pressure relief valve apparatus, according to an embodiment.

FIG. 4 is a front perspective view of an electronic control system for controlling a pressure relief valve system, according to an embodiment.

FIG. 5 is a block diagram of an example computing device configured to implement pressure relief valve control techniques described herein, according to an embodiment.

FIG. 6 illustrates an example method for controlling a pressure relief valve, according to an embodiment.

The headings provided herein are for convenience only and do not necessarily affect the scope or meaning of what is claimed in the present disclosure.

Embodiments of the present disclosure and their advantages are best understood by referring to the detailed description that follows. It should be appreciated that like reference numbers are used to identify like elements illustrated in one or more of the figures, wherein showings therein are for purposes of illustrating embodiments of the present disclosure and not for purposes of limiting the same.

### DETAILED DESCRIPTION

Various examples and embodiments of the present disclosure will now be described. The following description provides specific details for a thorough understanding and enabling description of these examples. One of ordinary skill in the relevant art will understand, however, that one or more embodiments described herein may be practiced without many of these details. Likewise, one skilled in the relevant art will also understand that one or more embodiments of the present disclosure can include other features and/or functions not described in detail herein. Additionally, some well-known structures or functions may not be shown or described in detail below, so as to avoid unnecessarily obscuring the relevant description.

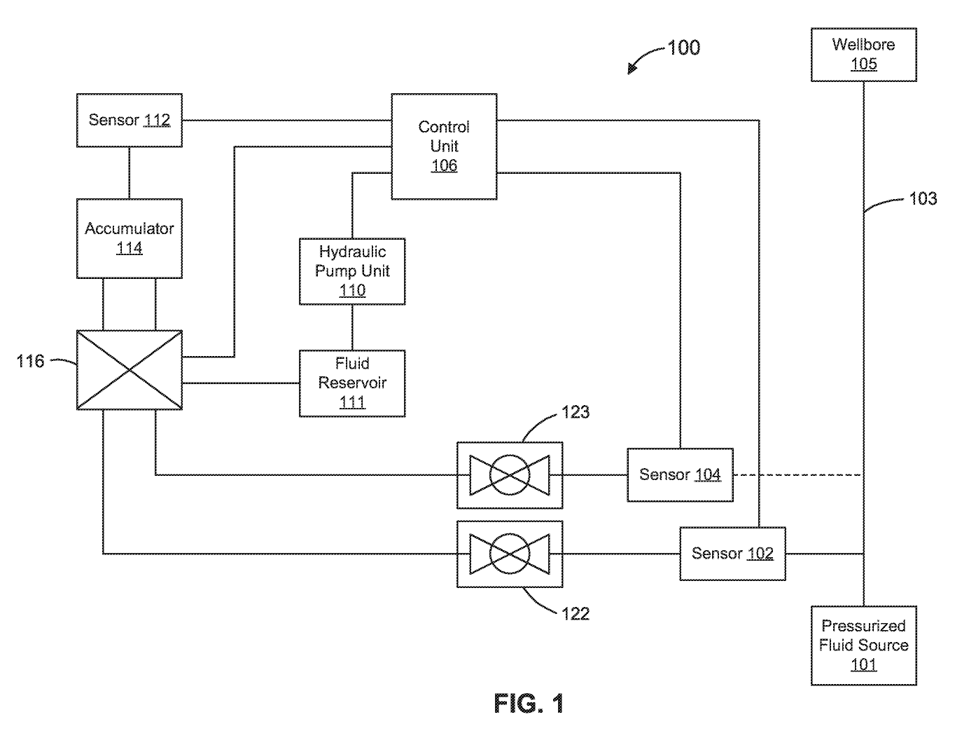

FIG. 1 schematically illustrates an example pressure relief valve system 100 for relieving pressure in a high pressure tubing according to one or more embodiments. In at least one embodiment, a pressurized fluid source 101, such as frac fluid pumps as an example, supplies pressurized fluid through a high pressure tubing 103 to a wellbore 105. The pressurized fluid is pumped into the wellbore 105 in order to perform a fracturing operation therein. The pressure relief valve system includes one or more sensors 102, 104 to monitor the pressure of the frac fluid in the high pressure tubing 103. In the embodiment illustrated in FIG. 1, the system 100 includes two sensors 102 and 104, where the sensor 102 is deployed proximate the inlet of a first relief valve assembly 122 and the sensor 104 is deployed proximate the inlet of a second relief valve assembly 123. Assembly 123 is redundant to assembly 122 so that in the event of a malfunction or failure of assembly 122, the relief valve assembly 123 can take assembly 122's place in the system 100. In some embodiments, the relief valve assemblies 122 and 123 are hydraulically actuated valves that include an actuator to move a valve between open and closed positions. As an example, assemblies 122 and 123 are hydraulically actuated gate valves that can vent the high pressure tubing 103 to ambient (e.g., atmosphere) in order to prevent an over-pressurization condition. Relief valve assemblies 122 and 123 and their manner of actuation will be explained in further detail below.

In the embodiment shown in FIG. 1, the sensors 102, 104 are communicatively coupled to a control unit 106 (e.g., an electronic control device or electronic control system) so that the control unit 106 can receive the indications of the fluid pressure monitored by the sensors 102, 104. The control unit 106 then responds to the pressure indications with appropriate control signals to activate the pressure relief valve assemblies 122, 123, as will be further described below. The sensors 102, 104 can be any of a variety of known transducers for monitoring pressure and providing signals indicative of the monitored pressure, such as piezoelectric transducers as one example.

The system 100 also includes an accumulator 114 which stores or is charged with pressurized hydraulic fluid to actuate the valve assemblies 122, 123 for at least several cycles. In an embodiment, the accumulator 114 is coupled or connected to a hydraulic pump unit 110. The hydraulic pump unit 110 charges the accumulator 114 with fluid that is stored in a fluid reservoir 111. A hydraulic sensor 112 is coupled to the accumulator 114 to monitor the stored charge. The sensor 112 provides indications of the stored charge to the control unit 106 so that the control unit 106 can maintain the charge in the accumulator 114 at a desired level. As an example, if hydraulic sensor 112 detects that the charge in the accumulator 114 drops below a level that is sufficient to actuate the valve assembly 122 or 123 (e.g., 1500 psi), then the control unit 106 energizes the hydraulic pump unit 110 to re-charge the accumulator 114 with fluid from reservoir 111. When the hydraulic sensor 112 detects that the accumulator 114 has been re-charged to a desired level (e.g., 2500 psi), then the control unit 106 de-energizes the hydraulic pump unit 110.

In the embodiment illustrated in FIG. 1, the accumulator 114 is in fluid communication with the hydraulically activated relief valve assemblies 122, 123 through a valve 116. The valve 116 is controlled by the control unit 106 in order to actuate relief valve assembly 122 or 123. As an example, in the event that sensor 102 or 104 indicates an over-pressurization condition (e.g., an activation condition) in the tubing 103, the control unit 106 generates a control signal that activates valve 116 to provide a fluid communication path between the accumulator 114 and the valve assembly 122 or 123. The accumulator 114 supplies sufficient pressurized hydraulic fluid to activate hydraulically-actuated valve assembly 122 or 123 so that the tubing 103 is vented to ambient (e.g., atmosphere). In an embodiment, when the pressure in the tubing 103 drops below a threshold level (e.g., a reset level), the control unit 106 can again activate the hydraulically-actuated relief valve assembly 122 or 123 so that the assembly 122 or 123 is placed in a closed position.

The reset threshold can be any value (e.g., pressure value (psi)) that is lower than the activate or trigger value or threshold for venting or opening the relief valve assembly 122 or 123. For example, in an embodiment, the reset value may be a value that is 2,500 psi less than the trigger threshold value to allow the valve assembly 122, 123 to rest momentarily before closing back up. As another example, if the burst rating of a given casing in the wellbore 105 (e.g., set by the manufacturer of the casing and in accordance with API standards) is 10,000 psi, then a suitable trigger threshold (or “activate” value) may be 8,000 psi, and a suitable reset value may be 5,500 psi. According to some embodiments, the trigger threshold may be set via the electronic control unit 106, thereby providing a system that allows an operator to adjust the thresholds or “pop-off” (e.g., activation) settings as desired. In an embodiment, the settings can be adjusted in real-time without interrupting the fluid flow in tubing 103 or the operation being performed. Regardless of when or the manner in which the thresholds are set, when the desired trigger value (pressure setting) is sensed by one or more of the sensors 102, 104, the pressure relief valve system 100 activates so that the pressure in the tubing 103 can be relieved.

A person skilled in the art will understand that the trigger threshold will vary depending on the particular application in which the pressure relief system 100 is employed. For instance, when used in a fracturing operation in a wellbore (e.g., wellbore 105), the threshold values are dependent on at least the over-pressurization ratings of the high pressure tubing 103 and the casing in the wellbore 105, as examples. The trigger threshold can be set at appropriate pressure values (e.g., via the electronic control unit 106) for the particular application. For example, in one embodiment, the trigger pressure may be set to be 9800 psi with the reset value at 300 psi. In various other embodiments, the trigger pressure and the reset value may range between 0-15,000 psi, with the reset value being lower than the trigger pressure.

In the embodiment of FIG. 1, the valve 116 also provides a fluid communication path between the relief valve assembly 122 or 123 and fluid reservoir 111 so that hydraulic fluid used to actuate the hydraulically-actuated valve assembly 122 or 123 can be exhausted back to the fluid reservoir 111. The hydraulic fluid that is directed to the reservoir 111 can later be used to re-charge the accumulator 114 as needed.

According to an embodiment, the system 100 further includes a battery backup (not shown) so that the system 100 can continue to operate if main power (e.g., generator power) to the system 100 or at the site at which the system 100 is deployed is interrupted or lost. The system 100 also may have an Ethernet or other wired or wireless communication connection to the electronic control unit 106 (e.g. a computer or processor) that controls the system 100 and monitors and records performance.

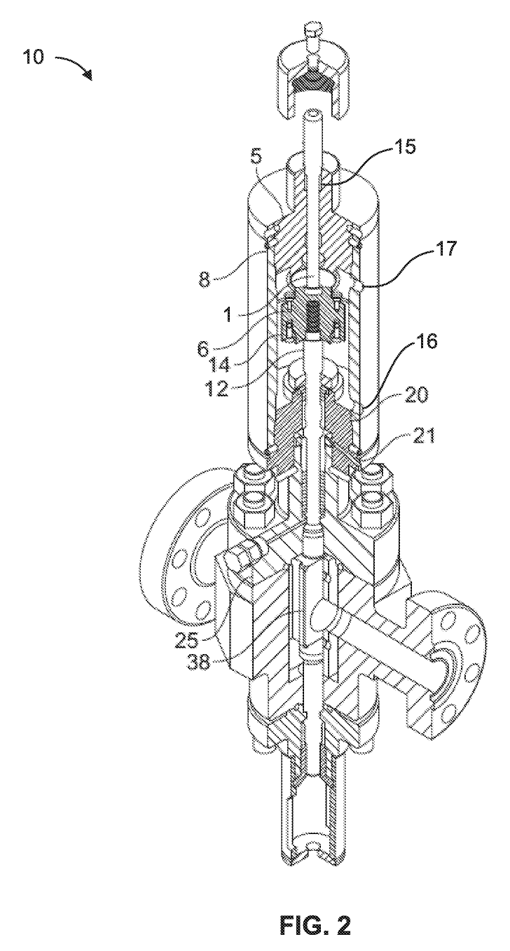

According to an embodiment, the electronic control unit 106 is configured to monitor and record (e.g., store in a storage or memory device of the electronic control unit 106) performance, as well as control the operation of the hydraulically-actuated valve assembly 122 or 123. FIG. 2 is a cutaway view of one example of a hydraulically-actuated relief valve assembly 10 that can be implemented in a pressure relief valve system, such as the system 100 shown in FIG. 1. In the embodiment shown in FIG. 2, the relief valve assembly 10 is configured as a double-acting hydraulic actuator valve that corresponds to the relief valve assembly 122 or 123 shown in FIG. 1. According to an embodiment, the double-acting hydraulic valve assembly 10 is operated by application of adequate hydraulic pressure to an upper port 17 and a lower port 16 of a hydraulic housing 8. For example, the hydraulic pressure can be supplied to ports 17 and/or 16 via flexible tubing or other fluid conduit that couples the accumulator 114 in FIG. 1 to the assembly 10 through the hydraulic valve 116. In general, hydraulic fluid supplied to ports 17 and/or 16 exerts pressure on an internal piston 6 that then forces a bonnet stem 25 to either open or close a gate 38.

In an embodiment, the hydraulic housing 8 of the assembly 10 includes an upper chamber and a lower chamber. Each of the upper and lower chambers has two ports located, for example, 180-degrees apart from each other, in an embodiment. For example, in an embodiment, the upper chamber of the assembly 10 can have two upper ports 17, where a first port 17 is in fluid communication with valve 116 and tank 111 for supply and/or exhaust of hydraulic fluid, and a second port 17 includes a burst disc that is configured to prevent over-pressurization of the upper chamber. The lower chamber of the assembly 10 has two lower ports 16, where a first port 16 is in fluid communication with valve 116 and tank 111 for supply and/or exhaust of hydraulic fluid, and a second port 16 includes a burst disc that is configured to prevent over-pressurization of the lower chamber. The upper ports 17 are positioned above the lower ports 16 in relation to a vertical orientation of the assembly 10, and any one of the ports 17 and 16 can be used as a supply port or an exhaust port. In at least one embodiment, each of the upper ports 17 and lower ports 16 are ½ inch. npt (American National Standard Taper Pipe Thread). Each of the upper ports 17 is located approximately 3.25 inches from one end (e.g., upper end) of the hydraulic housing 8, and each of the lower ports 16 is located approximately 3.25 inches from the other, opposite end (e.g., lower end) of the hydraulic housing 8, according to an embodiment. It should be noted that in some embodiments, the assembly 10 may include more than two upper ports 17, more than two lower ports 16, one or more of the upper ports 17 may be differently oriented or positioned with respect to one another (e.g., located other than 180-degrees apart), one or more of the lower ports 16 may be differently oriented or positioned with respect to one another (e.g., located other than 180-degrees apart), the upper ports 17 and/or the lower ports 16 may be differently spaced apart from their respective ends of the hydraulic housing 8 (e.g., other than 3.25 inches from the respective end of the housing), the upper ports 17 and/or the lower ports 16 may be of a different size than that indicated above, etc.

In an embodiment, the assembly 10 includes a top shaft 1, top cap 5, the piston 6, an operating stem 12, wear bearings 14, 15, the hydraulic housing 8, and base plates with bolts for holding the assembly together (not shown). In some embodiments, the assembly 10 may include various seals such as, for example, O-rings 20, 21. In an embodiment, the seals provide strength; low friction; wear resistance; ability to respond to temperature changes; and the ability to form a tight seal—all of which make the seals capable of withstanding hydraulic industrial application requirements.

In an embodiment, the operating stem 12 is coupled to the gate 38 that extends through the bonnet 25 to the internal piston 6 contained in the hydraulic housing 8. According to some embodiments, to operate the actuator and valve assembly 10 into the open position (e.g., where the gate 38 is open), pressure is applied to the lower chamber (below the piston 6) via a port 16, while pressure is reduced (or released) to the upper chamber via a port 17. The pressure applied to the lower chamber forces the piston 6 to rise, which causes the operating stem 12 and the gate 38 to be pulled along with the piston in the same direction, thereby opening the gate 38. In some embodiments, to operate the actuator and valve assembly 10 into the closed position (e.g., where the gate 38 is closed), pressure is applied to the upper chamber (above the piston 6) via a port 17, while pressure is being reduced (or released) to the lower chamber via a port 16. The pressure applied to the upper chamber forces the piston 6 downward, which, in turn, pushes the operating stem 12 and gate 38 in the same downward direction, thereby closing the gate 38.

According to some embodiments, the pressure relief valve system 100 of FIG. 1 may include a single-acting hydraulic actuator and valve assembly instead of a double-acting hydraulic actuator and valve (e.g., the double-acting hydraulic actuator and valve assembly 10 shown in FIG. 2 and described in detail above). In such embodiments, the single-acting hydraulic actuator and valve assembly may include some components that are similar in form and/or function to corresponding components of the double-acting hydraulic actuator and valve assembly 10. In an embodiment, the single-acting hydraulic actuator and valve assembly includes a spring or other resilient member for biasing the gate 38 to either the open or closed position. In an embodiment, the resilient member biases the gate 38 to an open position. According to an embodiment, the single-acting hydraulic actuator and valve assembly may operate in a similar manner as the double-acting hydraulic actuator and valve assembly 10. For example, in an embodiment, an operating stem of the single-acting hydraulic assembly is coupled to a gate that extends through a bonnet to an internal piston contained in a hydraulic housing. According to some embodiments, to operate the single-acting hydraulic actuator into an open position (e.g., where the gate is open), pressure is applied to the hydraulic housing, at a point above the piston holding the gate valve in the open position. The pressure applied to the hydraulic housing forces the piston to push the operating stem and gate downward, such that the gate is in an open position. In an embodiment, to operate the single-acting hydraulic actuator into the closed position (e.g., where the gate is closed), pressure is released from the hydraulic housing, above the piston. Releasing the pressure from the hydraulic housing causes a spring coupled to the piston to push the piston upwards, whereby the operating stem and gate are pulled upwards in the same direction such that the gate is closed.

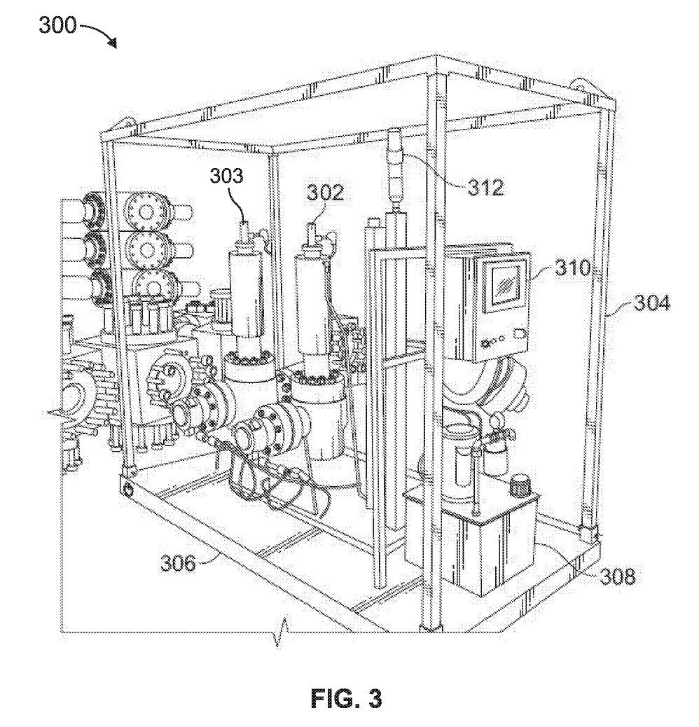

FIG. 3 is a perspective view of an apparatus 300 that includes a pressure relief valve system (e.g., pressure relief valve system 100 as shown in FIG. 1), according to an embodiment. In one or more embodiments, the pressure relief valve apparatus 300 includes all or components of the pressure relief valve system 100, and may be further designed for supporting, transporting, containing, etc. the pressure relief valve system 100 (or components thereof). As shown in FIG. 3, according to an embodiment, the pressure relief valve apparatus 300 includes a skid 306 having a cross bracing welded to a frame 304 of the skid 306. With the pressure relief valve system 100 assembled on the skid 306, the system 100 may be easily transported by, for example, a truck or trailer and can be lifted and/or moved using a crane.

According to an embodiment, the pressure relief valve apparatus 300 (and corresponding system) includes a hydraulic pump and reservoir assembly 308, a double acting hydraulic (DAH) gate valve assemblies 302 and 303, a battery/power backup system (not shown) and an electronic control system 310. In an embodiment, the pump and reservoir assembly 308 may be similar to the pump unit 110, accumulator 114, and tank 111 shown in FIG. 1; the electronic control system 310 may be similar to the electronic control unit 106 shown in FIG. 1; and the gate valve assemblies 302 and 303 may be similar to the hydraulically actuated relief valve assembly 122 and 123 shown in FIG. 1, all of which are described in detail above. In an embodiment, and as shown in FIG. 3, the pressure relief valve system carried by the skid 306 also may include a second gate valve assembly 303 that is configured to provide redundancy in the event of a malfunction or failure of the first gate valve assembly 302. FIG. 3 illustrates the skid 306 positioned proximate other equipment that may be present at or transported to a well site, such as various frac valves, frac pumps, etc.

The electronic control system 310 is configured to control the apparatus 300 (and the corresponding system), and to monitor and record various performance parameters of the apparatus 300 and system, according to an embodiment. The pressure relief valve apparatus 300 may further include a self-reporting diagnostic light 312 (which may also be referred to as a “system status diagnostic light,” “system operating status indicator,” or the like), according to an embodiment. In an embodiment, the system status diagnostic light 312 is configured to provide an operator of the apparatus 300 and/or system with a visual signal (e.g., indicator) of the current operating status of the apparatus 300 and/or system. The system status diagnostic light 312 is controlled, for example, by the electronic control system 310. For example, in an embodiment, the electronic control system 310 controls the activation and deactivation of the system status diagnostic light 312 based on various performance parameters of the apparatus 300 and/or system that are monitored by the electronic control system 310. For example, if the electronic control system 310 determines that pressure is being sensed in the pressure relief valve system (e.g., based on data obtained from one or more of pressure sensors 102/104 and hydraulic sensor 112 in the example system 100 shown in FIG. 1), the electronic control system 310 may control (e.g., generate and send an activation signal to) the system status diagnostic light 312 to illuminate in a red color. In another example, if the electronic control system 310 detects an electrical failure in the apparatus 300 or system, and/or determines that the apparatus 300 or system is running off of battery power, the electronic control system 310 may control the system status diagnostic light 312 to illuminate in a yellow color. In yet another example, if the electronic control system 310 determines that the pressure relief valve system is on and ready for use, and no issues have been detected, the electronic control system 310 may control the system status diagnostic light 312 to illuminate in a green color. It should be understood that the system status diagnostic light 312 may be configured, controlled, and/or utilized in numerous other ways in addition to or instead of the examples described above. For example, the system status diagnostic light 312 may be configured to provide visual indicators in accordance with one or more preferences of the operator.

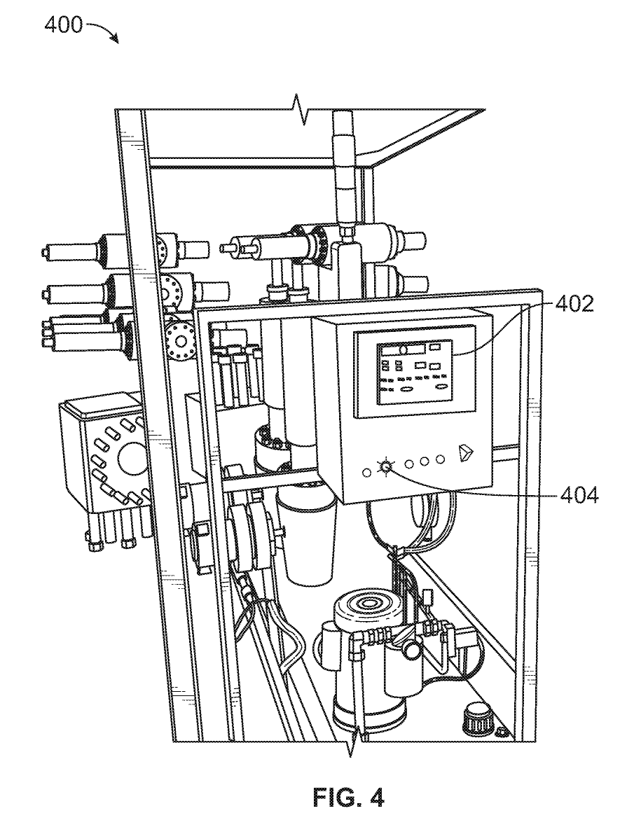

FIG. 4 is a front view of an electronic control unit 400 in a pressure relief valve system (e.g., system 100 shown in FIG. 1 and described in detail above), according to an embodiment. In an embodiment, the electronic control unit 400 is similar to the electronic control unit 106 of FIG. 1 and/or the electronic control system 310 of FIG. 3. In at least some embodiments, the electronic control unit 400 includes a display screen 402 and a plurality of LED lights 404. In some embodiments, the display screen 402 may display various information associated with the pressure relief valve system. For example, in an embodiment, the display screen 402 may display data associated with outputs from pressure sensors of the pressure relief valve system (e.g., one or more of pressure sensors 102/104 and hydraulic sensor 112 in the example system 100 shown in FIG. 1). In some embodiments, the display screen 402 may display information associated with the performance of an actuator in the pressure relief valve system (e.g., the actuator in the relief valve assembly 122, 123 in the example system 100 shown in FIG. 1). For example, the display screen 402 may display the pressure being read by the pressure sensors (e.g., one or more of pressure sensors 102/104 and hydraulic sensor 112 in the example system 100 shown in FIG. 1) in real-time, according to an embodiment. As another example, the display screen 402 may display information indicating whether the actuator is in the open position or the closed position. In at least one embodiment, the display screen 402 may display a character that allows an operator (e.g., user) to override the system and manually open the valve from the display screen 402 or from an attached computing device (e.g., laptop computer). According to some embodiments, the display screen 402 of the electronic control unit 400 is configured to receive input for monitoring and/or recording various performance parameters of the pressure relief valve system, and/or for controlling various operations or components of the pressure relief valve system. For example, in an embodiment, the trigger threshold for the pressure relief valve system may be set via input to the display screen 402 of the electronic control unit 400.

The electronic control unit 400 may also include a plurality of LED lights 404 to provide additional visual feedback, according to some embodiments. In at least one embodiment, each of the LED lights 404 may illuminate a different color of light, where each color corresponds to a particular meaning or indication. For example, in an embodiment, a green LED light may indicate that the system pressure is below a predetermined trigger threshold, a yellow LED light may indicate the system pressure is approaching the predetermined trigger threshold, and a red LED light may indicate that the system pressure is above the predetermined trigger threshold. A person of ordinary skill in the art should understand that any number of color LED light configurations may be used to visually display the above information. In some embodiments, one or more of the plurality of LED lights 404 may be configured to indicate various other information associated with the pressure relief valve system and/or components of the pressure relief valve system. For example, the plurality of LED lights 404 may indicate an operational status of the pressure relief valve system, according to some embodiments.

It should be noted that, in accordance with one or more embodiments, the electronic control unit and/or electronic control system referred to herein (e.g., electronic control unit 106 of FIG. 1, electronic control system 310 of FIG. 3, and electronic control unit 400 of FIG. 4) is a circuit (a type of electronic hardware) designed to perform complex functions defined in terms of mathematical logic. In some embodiments, the electronic control unit or system is (or includes) one or more of a microprocessor, a controller, an application-specific integrated circuit, and a field-programmable gate array.

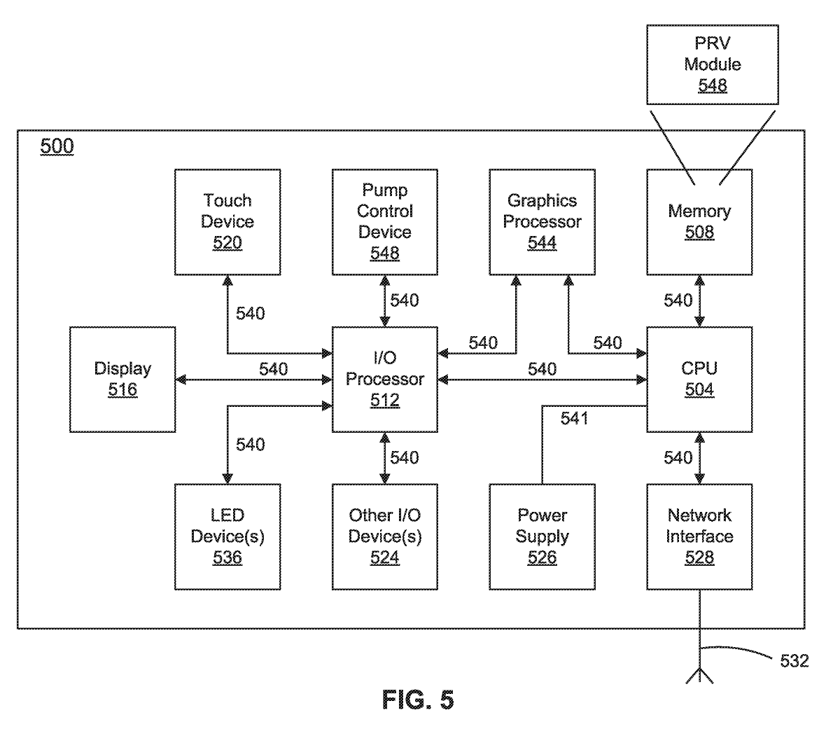

FIG. 5 is a block diagram illustrating an example computing device 500 (which may be, for example a mobile computing device) that may be configured to control a pressure relief valve or pressure relief valve system, according to some embodiments. In an embodiment, the computing device 500 may be implemented as an electronic control unit or system (e.g., electronic control unit 106 of FIG. 1, electronic control system 310 of FIG. 3, and electronic control unit 400 of FIG. 4) for controlling a pressure relief valve system, and for monitoring and recording various performance parameters of the system.

In an embodiment, the device 500 includes one or more central processing units (CPUs) 504 (hereinafter referred to as “the CPU 504” for purposes of brevity) coupled to at least one memory 508 (which can include one or more computer readable storage media such as random access memory (RAM), read only memory (ROM), FLASH memory, a hard disk drive, a digital versatile disk (DVD) disk drive, a Blu-ray disk drive, etc.). In at least one embodiment, the CPU 504 may also be coupled to a power supply 526 or source via, for example, a suitable power supply connection 541.

The device 500 also includes one or more input/output (I/O) processors 512 (hereinafter referred to as “the I/O processor 512” for purposes of brevity) that interfaces the CPU 504 with a display device 516 and a touch-sensitive device or touchscreen 520 (e.g., a single-touch or multi-touch touchscreen), according to an embodiment. For example, in an embodiment, the display device 516 and the touch-sensitive device 520 may comprise a display of an electronic control unit in a pressure relief valve system (e.g., display screen 402 of the electronic control unit 400 shown in FIG. 4).

In an embodiment, the I/O processor 512 may interface a pump control device 548 and one or more LED devices 536 to the CPU 504. In an embodiment, the one or more LED devices 536 may be similar to the plurality of LED lights 404 included in the electronic control unit 400 of FIG. 4. For example, the one or more LED devices 536 may be configured to cause different color lights to illuminate as indicators of various information or statuses associated with the pressure relief valve system and/or components of the pressure relief valve system. In at least one embodiment, the pump control device 548 may be configured to control the operation of a hydraulic pump (e.g., hydraulic pump unit 110 in the example system 100 shown in FIG. 1) to supply hydraulic pressure to an actuator (e.g., the actuator of relief valve assembly 122).

In some embodiments, the I/O processor 512 also may interface one or more additional I/O devices 524 to the CPU 504, such as, for example, one or more buttons, click wheels, a keyboard, a keypad, a touch pad, another touchscreen (single-touch or multi-touch), other lights, a speaker, a microphone, etc.

A network interface 528 is coupled to the CPU 504 and to one or more antennas 532, according to an embodiment. A memory card interface (not shown) may also be coupled to the CPU 504, in an embodiment. The memory card interface is adapted to receive a memory card such as, for example, a secure digital (SD) card, a miniSD card, a microSD card, a Secure Digital High Capacity (SDHC) card, etc., or any suitable card.

In an embodiment, the CPU 504, the memory 508, the I/O processor 512, the network interface 528, and the memory card interface (not shown) are coupled to one or more busses 540. For example, the CPU 504, the memory 508, the I/O processor 512, the network interface 528, and the memory card interface are coupled to a single bus 540, in an embodiment. In another embodiment, the CPU 504 and the memory 508 are coupled to a first bus, and the CPU 504, the I/O processor 512, the network interface 528, and the memory card interface are coupled to a second bus. In other embodiments, more than two busses are utilized. It should be noted that in some embodiments various other arrangements of components and busses may be utilized.

In at least one embodiment, the computing device 500 also may include a graphics processor 544 coupled to the display 516 and to the CPU 504. The graphics processor 544 may be coupled to the display 516 via the I/O processor 512. The graphics processor 544 may be coupled to the CPU 504 and the I/O processor 512 via one or more busses 540.

The device 500 is only one example of a computing device 500, and other suitable devices can have more or fewer components than shown, can combine two or more components, or a can have a different configuration or arrangement of the components. The various components shown in FIG. 5 can be implemented in hardware, one or more processors executing software or firmware instructions or a combination of both i) hardware and ii) one or more processors executing software or firmware instructions, including one or more integrated circuits (e.g., an application specific integrated circuit (ASIC)).

The CPU 504 executes computer readable instructions stored in the memory 508. The I/O processor 512 interfaces the CPU 504 with input and/or output devices, such as the display 516, the touch-sensitive device 520, the pump control device 548, the one or more LED devices 536, and other input/control devices 524. Similarly, the graphics processor 544 executes computer readable instructions stored in the memory 508 or another memory (not shown) associated with the graphics processor 544. The I/O processor 512 interfaces the graphics processor 544 with the display 516 and, optionally other input/control devices.

In an embodiment, the I/O processor 512 may include a display controller (not shown) and a touchscreen controller (not shown). The touchscreen or touch-sensitive device 520 includes one or more of a touch-sensitive surface and a sensor or set of sensors that accepts input from the user based on, for example, haptic and/or tactile contact. In some embodiments, the touchscreen 520 utilizes one or more of currently known or later developed touch sensing technologies, including, for example, one or more of capacitive, resistive, infrared, and surface acoustic wave technologies, as well as other proximity sensor arrays or other elements for determining one or more points of contact with the touchscreen 520. The touchscreen 520 and the I/O processor 512 (along with any associated modules and/or sets of instructions stored in memory 508 and executed by the CPU 504) can detect one or more points of or instances of contact (and any movement or breaking of the contact(s)) on the touchscreen 520, in some embodiments. Such detected contact can be converted by the CPU 504 into interaction with a user-interface mechanism that is displayed on the display 516. For example, a user can make contact with the touchscreen 520 using any suitable object or appendage, such as a stylus, a finger, etc. In some embodiments, the touchscreen 520 includes force sensors that measure an amount of force applied by a touch. In such embodiments, an amount of force applied in connection with a contact can be utilized to distinguish between different user-requested actions. For example, a contact made with a relatively light touch may correspond to a first requested action (e.g., select an object), whereas a relatively forceful touch may correspond to a second requested action (e.g., select an object and open a pop-up menu associated with the selected object).

In some embodiments, the network interface 528 facilitates communication with a wireless communication network such as a mobile communications network, a wireless local area network (WLAN), a wide area network (WAN), a personal area network (PAN), etc., via the one or more antennas 532. In other embodiments, one or more different and/or additional network interfaces facilitate wired communication with one or more of a local area network (LAN), a WAN, another computing device such as a personal computer, a server, etc.

Software components or modules (e.g., sets of computer readable instructions executable by the CPU 504) are stored in the memory 508 and/or a separate memory (not shown) associated with the graphics processor 544. The software components can include, for example, an operating system, a communication module, a contact module, a graphics module, a pressure relief valve (PRV) module 548, and applications such as a monitoring application, a computational application, a data processing application, etc., according to an embodiment. The operating system can include various software components and/or drivers for controlling and managing general system tasks (e.g., memory management, etc.) and can facilitate communication between various hardware and software components. The communication module can facilitate communication with other devices via the network interface 528, for example.

According to an embodiment, the contact module can detect contact with the touchscreen 520 (in conjunction with the I/O processor 512). The contact module can include various software components for performing various operations related to detection of contact, such as determining if contact has occurred, determining if there is movement of the contact and tracking the movement across the touchscreen 520 (in some embodiments), determining an amount of force in connection with the contact (in some embodiments), and determining if the contact has been broken (e.g., if the contact has ceased). Determining movement of the point of contact can include determining speed (magnitude), velocity (magnitude and direction), and/or an acceleration (a change in magnitude and/or direction) of the point of contact. These operations can be applied to single contacts (e.g., one finger contacts) or to multiple simultaneous contacts (e.g., “multi-touch”/multiple finger contacts), in some embodiments.

The graphics module can include various suitable software components for rendering and displaying graphics objects on the display 516. As used herein, the term “graphics” includes any object that can be displayed to a user, including without limitation text, web pages, icons, symbols, digital images, etc.

In an embodiment, the PRV module 548 includes various suitable software components for performing various operations related to monitoring the performance of a pressure relief valve system (e.g., pressure relief valve system 100 shown in FIG. 1) and/or components of a pressure relief valve system, and controlling various operations of the pressure relief valve system. For example, in an embodiment, the PRV module 548 monitors the performance of a relief valve assembly (e.g., relief valve assembly 122 or 123, which may be a hydraulically-actuated relief valve assembly). Based on various performance indicators, parameters, or measurements associated with the operation of the relief valve assembly, the PRV module 548 may perform various operations related to controlling the relief valve assembly including, for example, determining an over-pressurization condition (e.g., an activation condition) in the tubing 103, controlling a valve in order to actuate the relief valve assembly so that the tubing is vented to ambient (e.g., atmosphere), and activating the relief valve assembly so that the assembly is placed in a closed position.

In some embodiments, the PRV module 548 includes machine readable instructions that, when executed by one or more processors (such as the CPU 504 and/or the graphics processor 544), cause the one or more processors to (i) monitor an over-pressurization condition (e.g., in the tubing 103) based on measurements from a plurality of sensors, and (ii) in response to determining that the pressure is above a threshold pressure (e.g., trigger pressure), cause pressure to be supplied to a relief valve assembly in order to place the relief valve assembly in an open position, according to an embodiment.

In embodiments in which the CPU 504 executes at least portions of the PRV module 548, the PRV module 548 may be stored in the memory 508. In embodiments in which the graphics processor 544 executes at least portions of the PRV module 548, the PRV module 548 may be stored in the memory 508 and/or in another memory (not shown) of or coupled to the graphics processor 544. In some embodiments, the memory 508 is coupled to the graphics processor 544.

In accordance with one or more embodiments, each of the above-identified modules and applications can correspond to a set of instructions that, when executed by one or more processors, cause one or more functions described above to be implemented using the one or more processors. These modules need not be implemented as separate software programs, procedures, or modules, and thus various subsets of these modules can be combined or otherwise re-arranged in various embodiments. For example, in some embodiments, the PRV module 548 is a component of another module, such as an application module (not shown). In some embodiments, the memory 508 (and separate memory associated with the graphics processor, when included) stores a subset of the modules and data structures identified above. In other embodiments, the memory 508 (and separate memory associated with the graphics processor, when included) stores additional modules and data structures not described above.

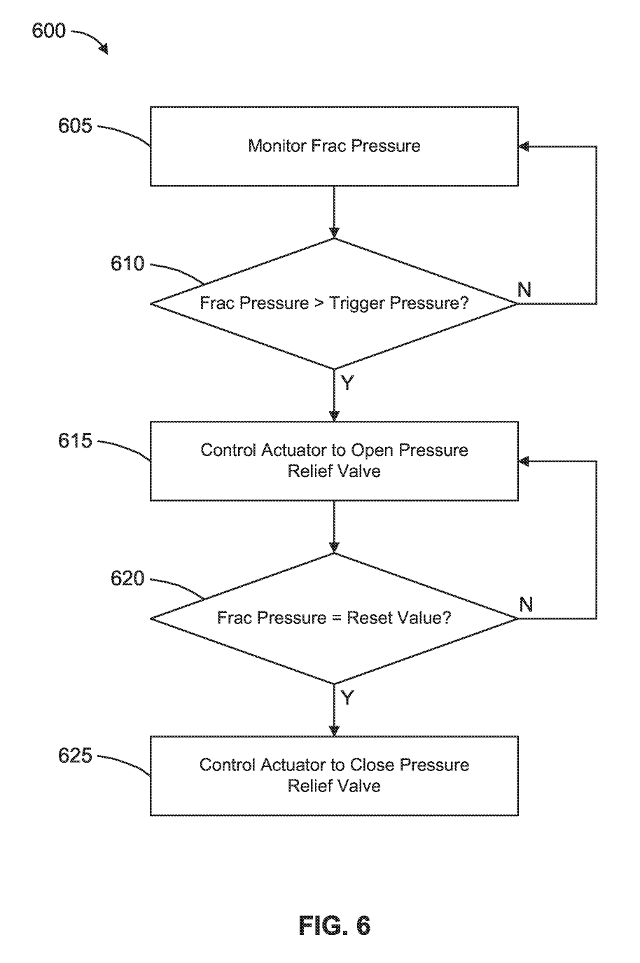

FIG. 6 illustrates an example method 600 for controlling a pressure relief valve to relieve pressure in a high pressure tubing that is conveying pressurized frac fluid between a pressurized fluid source and a wellbore, according to one or more embodiments. In some embodiments, the electronic control unit 106 in the example system 100 of FIG. 1 is configured to implement the method 600. The method 600 is described in the context of the electronic control unit 106 merely for explanatory purposes, however, and in other embodiments, the method 600 is implemented by another suitable device. In some embodiments, the method 600 may be performed in part by electronic control unit 106, and in part by one or more other suitable components of the pressure relief valve system.

At block 605, frac pressure is monitored. For example, in an embodiment, one or more sensors measure source pressure being supplied by a source of pressurized frac fluid (e.g., frac pumps)), and provide the pressure measurements to an electronic control unit (e.g., one or more of sensors 102, 104 measure the frac pressure in the tubing 103 that is being supplied by the pressurized fluid source 101, and provide such pressure measurements to electronic control unit 106, in the example system 100 shown in FIG. 1). The electronic control unit monitors the frac pressure, based on the measurements received (e.g., retrieved, otherwise obtained, etc.) from the pressure sensors, and at block 610, the frac pressure is compared to a trigger pressure threshold.

In some embodiments, the trigger threshold may vary depending on the application of the wellbore, and the trigger threshold may be set at various pressure values (e.g., by the electronic control unit 106). For example, in one embodiment, the trigger pressure may be set to be 9800 psi. In various other embodiments, the trigger pressure may range up to 15,000 psi. For example, if the burst rating of a given wellbore casing (e.g., set by the manufacturer of the casing and in accordance with API standards) is 10,000 psi, then a suitable trigger threshold (or “activate” value) may be 8,000 psi.

If it is determined at block 610 that the monitored frac pressure is not greater than the set trigger pressure threshold, the process may return to block 605. On the other hand, if it is determined at block 610 that the monitored frac pressure is greater than the set trigger pressure threshold, then at block 615 the actuator may be controlled to open the pressure relief valve. For example, with reference to FIG. 2, according to some embodiments, to operate the actuator of assembly 10 into the open position (e.g., where the gate 38 is open), pressure is applied to the lower chamber, below the piston 6, while pressure is reduced (or released) to the upper chamber. The pressure applied to the lower chamber forces the piston 6 to rise, which causes the operating stem 12 and the gate 38 to be pulled along with the piston in the same direction, thereby opening the gate 38. With reference to FIG. 1, in an embodiment, the electronic control unit 106 may control the hydraulic pump unit 110 to supply hydraulic pressure to the actuator of the relief valve assembly 122 to open the valve, which will vent the system to the atmosphere, thereby lowering the pressure in the tubing 103, according to an embodiment.

At block 620, it may be determined whether the frac pressure has been reduced (e.g., lowered) to a predetermined level (e.g., a reset value). In some embodiments, determining whether the frac pressure has been reduced to a predetermined level includes determining whether the pressure within the system has been reduced to a predetermined level or reset value (e.g., so as to avoid causing any damage to the casing). For example, in an embodiment, the electronic control unit may monitor the frac pressure based on pressure measurements obtained from one or more pressure sensors, and compare the monitored frac pressure to a predetermined reset value.

In an embodiment, the “reset” value may be any value (e.g., pressure value (psi)) that is lower than the trigger pressure threshold (or “activate” value) used for activating the actuator to open the pressure relief valve. For example, in an embodiment, the reset value may be a value that is 2,500 psi less than the trigger threshold value to allow the pressure relief valve (e.g., the gate valve of assembly 122) to rest momentarily before returning to a closed position. As another example, if a trigger pressure threshold (or “activate” value) is set at 8,000 psi, then a suitable reset value may be 5,500 psi, according to an embodiment. In some embodiments, the reset value may be the same as the trigger value (e.g., used in the comparison at block 610).

If it is determined at block 620 that the frac pressure has not been reduced or lowered to at least the reset value, the process may return to block 615. On the other hand, if it is determined at block 620 that the frac pressure has been reduced to the predetermined reset level, then at block 625 the actuator may be controlled to close the pressure relief valve. For example, with reference to FIG. 2, according to some embodiments, to operate the actuator of assembly 10 into the closed position (e.g., where the gate 38 is closed), pressure is applied to the upper chamber, above the piston 6, while pressure is being reduced (or released) to the lower chamber. The pressure applied to the upper chamber forces the piston 6 downward, which, in turn, pushes the operating stem 12 and gate 38 in the same downward direction, thereby closing the gate 38.

While embodiments have been described with reference to applications in wellbores for monitoring and relieving pressure during hydraulic fracturing operations, this should not be construed as limiting. One or more embodiments may also be advantageously utilized in other applications. For example, the system for controlling a pressure relief valve can be used to monitor numerous other applications that operate with high pressure fluid activities.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. Descriptions of features or aspects within each embodiment should typically be considered as available for other similar features or aspects in other embodiments unless stated otherwise. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. A system for controlling a pressure relief valve, the system comprising:
an actuator that operates to move the pressure relief valve between an open position and a closed position; and
a control unit that controls operation of the actuator;
wherein the control unit is configured to:
monitor hydraulic pressure being supplied from a source, and
responsive to determining that the pressure is above a threshold pressure, control the actuator to move the pressure relief valve to the open position.

2. The system of claim 1, wherein the control unit is configured to:
responsive to determining that the hydraulic pressure satisfies a predetermined reset value, control the actuator to move the pressure relief valve to the closed position.

3. The system of claim 1, wherein the control unit is configured to monitor the pressure being supplied from the source based on measurements received from a plurality of sensors.

4. The system of claim 1, further comprising:
a plurality of sensors communicatively connected to the control unit, wherein the plurality of sensors measure the hydraulic pressure being supplied from the source.

5. The system of claim 1, further comprising:
an accumulator that stores pressurized hydraulic fluid for activating the actuator; and
a hydraulic power unit that supplies pressure to the accumulator.

6. The system of claim 5, wherein the hydraulic power unit comprises a motor coupled to a hydraulic pump, and
wherein the control unit is configured to:
control the motor and the hydraulic pump of the hydraulic power unit to supply pressure to the actuator.

7. The system of claim 1, wherein the actuator is a double-acting actuator.

8. The system of claim 1, wherein the actuator is a single-acting actuator.

9. The system of claim 1, further comprising:
a skid having a cross bracing welded to a frame of the skid.

10. The system of claim 1, further comprising:
at least one visual signaling device configured to generate a visual indicator based on a determined status of the system.

11. The system of claim 1, wherein the control unit comprises:
a display screen; and
a plurality of LED lights, wherein
the display screen is configured to display data associated with the pressure relief valve system.

12. The system of claim 11, wherein the data associated with the pressure relief valve system includes one or more of:
data associated with hydraulic pressure measurements obtained by the plurality of sensors;
data associated with system pressure measurements obtained by the plurality of sensors; and
an operating status of the actuator.

13. A method for controlling a pressure relief valve, the method comprising:
monitoring, using one or more sensors, hydraulic pressure supplied from a source;
responsive to determining that the monitored pressure is greater than a threshold value, controlling an actuator to move the pressure relief valve to an open position; and
responsive to determining that the monitored pressure is less than or equal to the threshold value, controlling the actuator to move the pressure relief valve to a closed position.

14. The method of claim 13, wherein controlling the actuator to move the pressure relief valve to the open position includes:
supplying pressure to the actuator to cause the actuator to open the pressure relief valve.

15. The method of claim 14, wherein supplying pressure to the actuator includes:
controlling a motor and a hydraulic pump to supply the pressure to the actuator.

16. The method of claim 13, further comprising:
generating a visual signal to indicate whether the pressure relief valve is in the open position or the closed position.

17. The method of claim 13, wherein the actuator is a double-acting hydraulic actuator.

18. The method of claim 13, wherein the actuator is a single-acting hydraulic actuator.
